(19) United States
(12) Patent Application Publication
(10) Pub. No.: US 2004/0154885 A1
(43) Pub. Date: Aug. 12, 2004

(54) Pad for caliper of disc brake

(76) Inventors: Giovanni Gotti, Alme (IT); Giovanni Mario Tironi, Dalmine (IT); Cristian Crippa, Almenno San Salvatore (IT)

Correspondence Address: Hogan & Hartson, Columbia Square, 555 Thirteenth Street NW, Washington, DC, 20004-1109, US

(21) Appl. No.: 10/450,823

(22) PCT Filed: Jul. 22, 2002
(86) PCT No.: PCT/IT02/00484

(51) Int. Cl. F16D 65/38

(52) U.S. Cl. 188/250 B; 188/250 F; 188/73.39

(57) ABSTRACT

The present invention relates to a pad for disc- brake calipers, comprising a plate for supporting a friction lining and having at least one seat which can engage a corresponding support pin suitable for supporting the pad in a caliper body, the support pin establishing a reaction to the frictional force exerted by a brake disc against the friction lining during a braking operation, wherein the at least one seat is formed at the bottom in a manner such that the pad is supported astride the support pin and that the point of abutment of the support pin in the seat is disposed to the rear of the centre of gravity of the pad during said braking operation.

### FIELD OF THE INVENTION

The subject of the present invention is a pad for disc-brake calipers and, more particularly, for fixed calipers suitable for housing at least one pair of such pads.

### BACKGROUND OF THE INVENTION

As is widely known, the disc-braking systems which are currently on the market generally comprise a caliper body extending astride a braking disc, at least one pair of facing pads disposed on opposite sides of the disc and restrained on the caliper body, each pad having a plate for supporting a friction lining, thrust units, and stop means for restraining the pads in a direction tangential to the disc.

In particular, the pads have a substantially rectangular shape with an upper longer side, a lower longer side, a front shorter side, a rear shorter side, an inner face and an outer face.

In the present description, the term “upper” is used to identify any element of the braking system or parts thereof which face towards the periphery of the disc when the element is in normal operative conditions. Similarly, the term “lower” is used to identify any element of the braking system or parts thereof which face towards the centre of the disc when the element is in normal operative conditions.

Furthermore, the term “inner” is used to identify any element of the braking system or parts thereof which face towards the surface of the braking band of the braking disc in normal operative conditions. Similarly, the term “outer” is used to identify any element of the system or parts thereof facing away from the braking band on which the pad acts in normal operative conditions.

Finally, the term “front” is used to identify any element of the braking system or parts thereof which face towards the disc exit when a vehicle on which the system is mounted is in motion. The term “rear”, on the other hand, identifies anything which faces towards the disc entry when the vehicle is in motion.

Various methods are known for restraining the pads on the caliper.

For example, the pad may have two lateral surfaces or shoulders provided with seats suitable for abutting two pins disposed at the front and at the rear of the pad. In particular, the pad is kept in abutment with the pins by resilient means.

Finally, a pin is housed in an eyelet formed in the upper edge of the pad so as to prevent rotary movements of the pad in its own plane. Moreover, the eyelet projects from the centre of the upper longer side of the pad.

It should be noted that the shoulders are positioned in a manner such as to receive the front and rear pins at the opposite lower corners of the pad.

In other words, the front and rear reaction pins are positioned at the bottom of the pad and in a manner such that one of them is arranged upstream and one downstream of the centre of gravity of the pad.

A pad of the above-mentioned type is described, for example, in German patent DE 44 16 815.

However, this pad has considerable disadvantages.

During a braking operation, the pad tends to be inclined towards the braking disc with its rear shorter side. As a result, the rear shorter side of the pad tends to stick against the surface of the braking disc.

This phenomenon, which is known as “sticking” or “stick-slip” may cause vibration of the pad and may give rise to undesired noise.

There is consequently a great need to provide a pad for disc-brake calipers which does not vibrate and cause annoying noises during a braking operation.

### SUMMARY OF THE INVENTION

The problem underlying the present invention is therefore that of devising a pad for disc-brake calipers which has structural and functional characteristics such as to overcome the disadvantages mentioned.

This problem is solved by a pad for disc-brake calipers as described in the appended main claim.

### BRIEF DESCRIPTION OF THE DRAWINGS

Further characteristics and the advantages of the pad for disc-brake calipers according to the present invention will become clear from the following description of some preferred embodiments thereof, given by way of non-limiting example, with reference to the appended drawings, in which:

FIG. 1a is a perspective view of a pad for disc- brake calipers according to the invention,

FIG. 1b is a view of the pad of FIG. 1a from the outer side,

FIG. 1c is a side view of the pad of FIG. 1a,

FIG. 1d is a view of the pad of FIG. 1a from the inner side,

FIG. 2 is a perspective view of a half-caliper according to the invention,

FIG. 3 is a perspective view of the half-caliper of FIG. 2, provided with the pad of FIG. 1a,

FIG. 4 is an exploded view of a caliper of a braking system provided with the pad of FIG. 1,

FIG. 5 is a perspective view of the caliper of FIG. 4, assembled,

FIG. 6 is a schematic view of the pad of FIG. 1a, in use,

FIG. 7 is a schematic view of a pad in use, according to a first variant of the invention,

FIG. 8 is a schematic view of a pad in use, according to a second variant of the invention,

FIG. 9 is a schematic view of a pad in use, according to the third variant of the invention,

FIG. 10 is a schematic view of a pad in use, according to a fourth variant of the invention,

FIG. 11 is a schematic view of a pad in use, according to a fifth variant of the invention,

FIG. 12 is a schematic view of a pad in use, according to a sixth variant of the invention.

### DETAILED DESCRIPTION

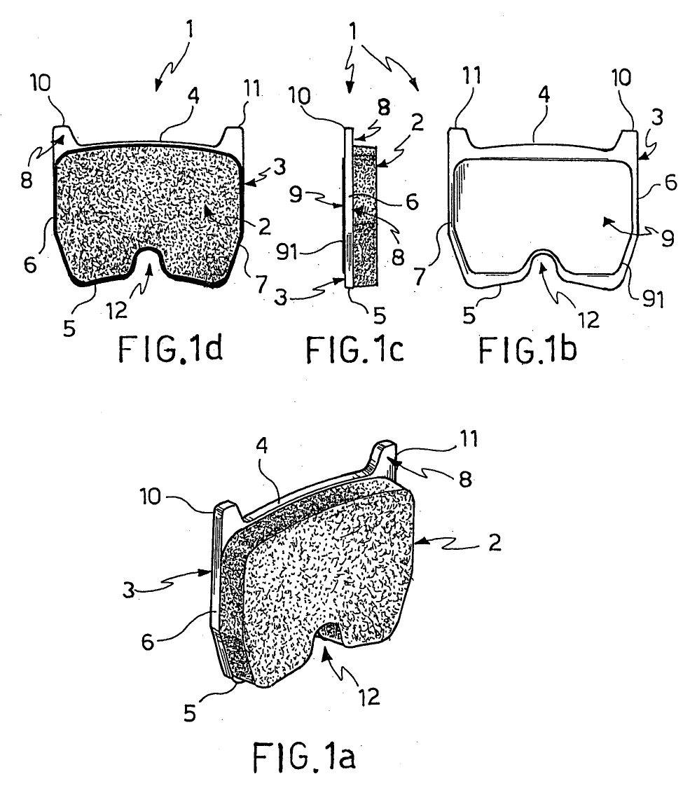

With reference to appended FIGS. 1a to 6, a pad for disc-brake calipers according to the invention is indicated 1.

The pad 1 comprises a friction material 2 supported by a plate 3.

As shown in FIGS. 1a to 1d, the plate 3 is in the form of a substantially rectangular element having an upper longer side 4, a lower longer side 5, a front shorter side 6, a rear shorter side 7, an inner face 8, and an outer face 9.

The upper longer side 4 has a front projection 10 and a rear projection 11 positioned substantially at the two ends of the side. These front and rear projections 10 and 11 constitute means for stopping movement of the pad in the direction of rotation of a brake disc during a braking operation, as will be explained further below.

The lower longer side 5 has a seat 12, formed substantially in the centre of the side, for receiving a support pin, as will be explained further below.

In particular, according to a first embodiment of the invention, the seat 12 has a semicircular or U-shaped profile.

The friction material 2 is supported on the inner face 8 of the pad 1 so as to cover substantially the whole surface thereof. The friction material 2 may be any material generally used in the field.

The outer face 9 of the pad 1, on the other hand, is suitable for being subjected to the thrust force produced by at least one piston (not shown), operated, for example, by a wholly conventional hydraulic system (not shown).

The outer face 9 is preferably provided with a vibration-damping plate 91, as in the example shown.

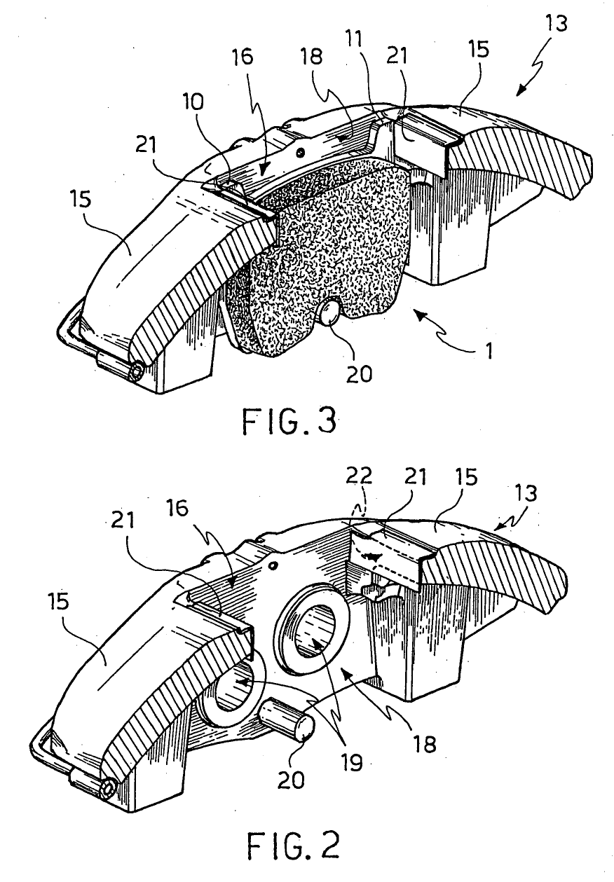

The mounting of the pad 1 of the present invention will now be described with reference to FIGS. 2 to 5.

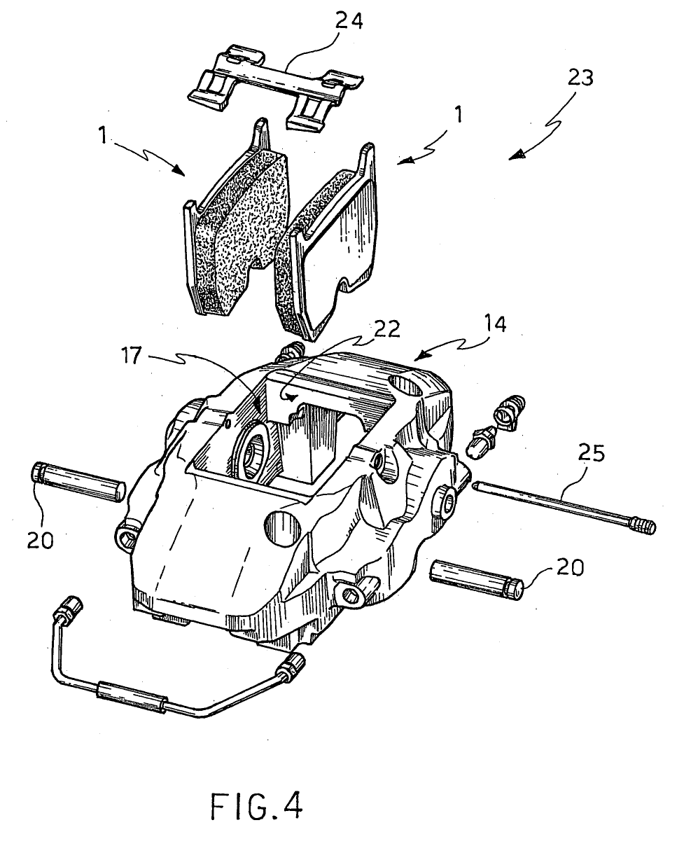

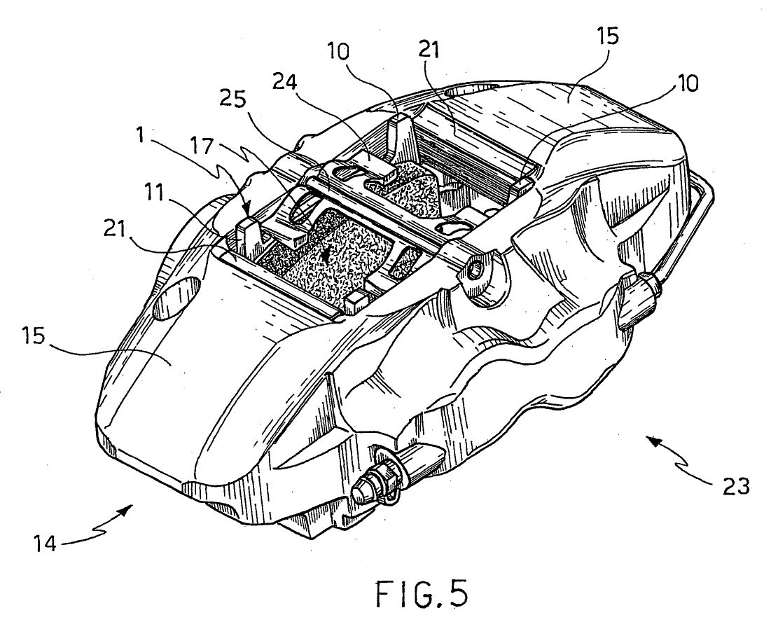

FIG. 2 shows a half-caliper 13 resulting from the longitudinal splitting of a caliper body 14 shown in FIGS. 4 and 5, in the region of its bridges 15 and at the level of the centreline of the disc.

This half-caliper 13 has an upper opening 16 which cooperates with the analogous upper opening of the other half-caliper to define the upper opening 17 of the caliper body 14, as shown in FIGS. 4 and 5.

The half-caliper 13 also has an inner surface 18; two circular holes of respective cylinders for housing conventional pistons 19 acting on the pad 1 open in the surface 18.

A support pin 20 is inserted in the caliper body 14 through a suitable hole so as to project for a predetermined distance from the inner surface 18.

Plates 21, only one half of each of which is shown in FIGS. 2 and 3, are arranged to protect abutment surfaces 22 (only one is shown in broken outline in FIG. 2) of the bridges 15 of the half-caliper 13 which surfaces are abutted by each pad 1 during a braking operation, as will be explained further below.

At this point, the pad 1 is inserted into the half-caliper 13 from the upper opening 16 until the seat 12 is engaged astride the support pin 20, as shown in FIG. 3.

FIG. 4 is an exploded view of a caliper 23 of a braking system comprising a caliper body 14, two pads 1 in the vicinity of the upper opening 17 of the caliper body 14, two support pins 20 for the pads 1, and a spring 24 which can be arranged in abutment with the pads 1 in known manner, by means of a restraint pin 25.

FIG. 5 shows the caliper 23 of the braking system of FIG. 4 in the assembled configuration, further comprising the above-described plates 21, disposed on the abutment surfaces 22 of the bridge 15 of the caliper body 14.

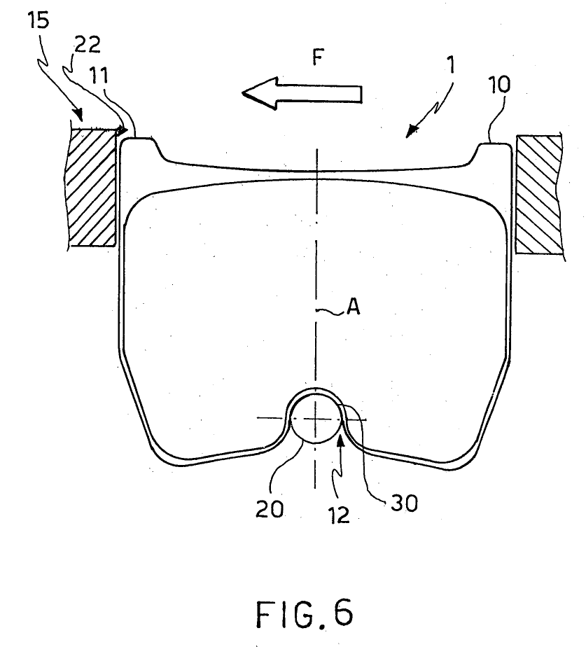

The operation of the pad 1 according to the present invention will now be described with reference to FIG. 6.

During a braking operation, as is widely known, when the pad 1 comes into contact with the surface of a braking band of a brake disc (not shown), a frictional force is created between the pad and the brake disc and is directed in the direction of rotation of the brake disc, as shown by the arrow F.

As a result of the effect of the frictional force, the pad 1 is dragged along in the direction of rotation of the brake disc. In other words, the pad 1 is moved in a plane parallel to the surface of the braking band of the brake disc. However, this movement is minimal so as to allow the seat 12 of the pad 1 to engage in abutment with the support pin 20 in a non-abrupt manner.

The engagement between the seat 12 and the support pin 20 takes place at an abutment point 30, that is, a point at which at least some of the frictional force is discharged from the pad to the pin, as shown by way of indication in FIG. 6.

Moreover, at the same time, the front projection 10 also comes into abutment with the forward facing abutment surface 22 of the bridge 15.

The abutment surface 22 also constitutes a reaction point which opposes the frictional force.

The abutment point 30 between the seat 12 and the support pin 20 is advantageously situated to the rear of the centre of gravity A of the pad 1.

In particular, the abutment point 30 is situated in the quarter circle facing towards the rear, relative to the centre of gravity of the pad 1.

It should also be noted that the abutment between the seat 12 and the pin 20 takes place not only to the rear of the centre of gravity A of the pad 1, but also on the rear of the support pin 20.

It has, in fact, surprisingly been observed that, by thus moving the abutment point 30 to the rear of the centre of gravity A of the pad, that is, by moving it towards the rear, the above-mentioned “sticking” or “stick-slip” phenomenon which is typical of the pads of the prior art discussed above is considerably reduced.

Experimental tests have shown that the unusual effect just described is achieved precisely by virtue of the fact that a pad has been devised which engages astride a single support pin in a manner such that its engagement, during a braking operation, takes place at a single abutment point which is always disposed to the rear of the centre of gravity A of the pad.

It has also been found that the further the single abutment point is moved, always towards the rear, from the centre of gravity of the pad, the more the “sticking” effect is attenuated.

As a result, the above-mentioned vibrations are eliminated or at least substantially reduced, to the extent that the consequent extremely annoying noises disappear or are considerably reduced.

In other words, for the elimination of the sticking effect, the movement of the abutment of the pad, that is, the point of application of the reaction to the braking force, towards the input of the disc brings the pad towards a position of stable equilibrium when the forces that are developed during braking act thereon. In particular, when the abutment point is at the output of the disc, the moment of the forces involved during a braking operation tends to bring the entire pad towards the disc so that there is an increase in specific pressure in the disc entry region. In other words, the pad works in conditions of unstable equilibrium in the sense that, if it did not encounter the disc, it would continue to pivot.

When the abutment point is at the disc entry, this moment tends to take the entire pad away from the disc. In this situation, the pad works in a condition of stable equilibrium in the sense that, even if there were no disc or pistons, it would be brought to a position of stable equilibrium.

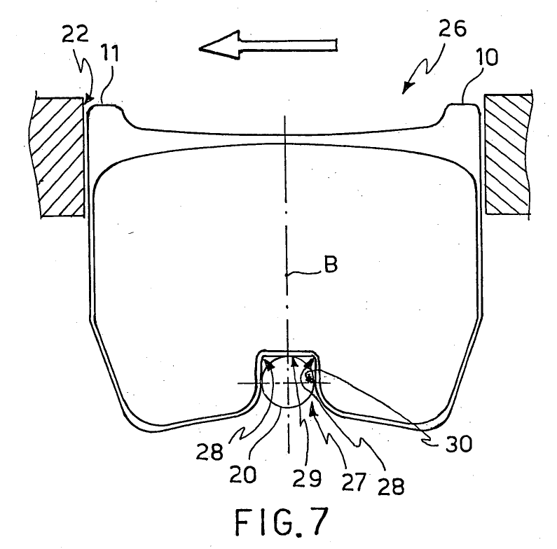

FIG. 7 shows a first variant of the pad for disc-brake calipers according to the invention.

The elements or parts of elements in common with the embodiment described above are again indicated by the same reference numerals and do not therefore need further description.

In general, the pad 26 of FIG. 7 has a shape substantially identical to the shape of the pad 1 described above.

In detail, however, the pad 26 has a seat 27 which can be arranged astride a support pin 20. The seat 27 has a substantially square profile defined by two opposed surfaces 28 each of which defines a plane substantially perpendicular to the upper longer side 4 of the pad 26, and by a base 29 which defines a plane substantially parallel to the plane defined by the upper longer side 4.

The advantage afforded by this variant of the invention lies in the fact that the abutment point between the support pin 20 and the seat 27 is defined precisely at the point of contact 30 between the circular-sectioned pin 20 and the surface 28 which is tangential thereto and is situated to the rear of the centre of gravity B of the pad 26.

The fact that the point of abutment between the seat of the pad and the support pin is defined substantially precisely means that there are no radial components of the reaction to the frictional force and the possibility of movements in the radial direction relative to the disc is consequently eliminated.

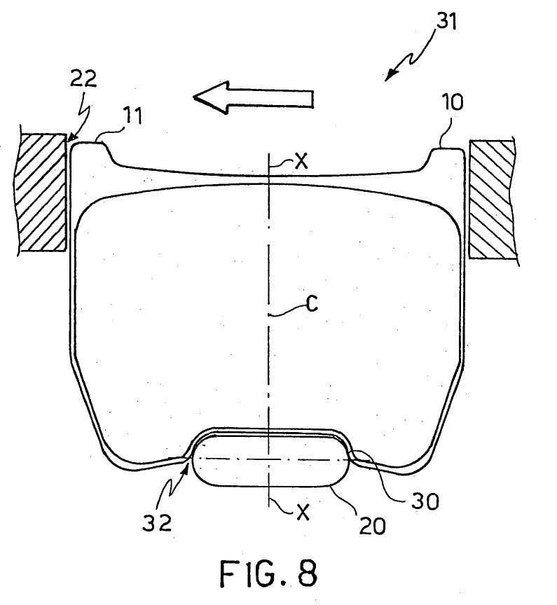

FIG. 8 shows a second variant of the present invention in which the pad 31 has a shape substantially identical to the shape of the pad 1 of FIG. 1, and the common parts are therefore identified by the same reference numerals.

In particular, the pad 31 has a seat 32 for the support pin 20, the seat having a substantially rectangular profile so as to receive the support pin 20 to the rear of the centre of gravity C of the pad 31. Moreover, the support pin 20 also has a substantially rectangular cross-section such as to extend to fit substantially the entire seat 32.

In other words, the seat 32 extends along the lower longer side 5 of the pad, symmetrically with respect to the axis X-X which extends through the centre of gravity C of the pad 31, and is perpendicular to the lower longer side.

The seat 32 advantageously enables its point of abutment with the support pin 20 to be moved further towards the rear, relative to the centre of gravity C of the pad 31, so that the above-mentioned “sticking” or “stick-slip” effect is further reduced, as described above.

A further advantage afforded by this embodiment is that the pad 31 can equally well be mounted on one side or on the other side of the brake disc.

Moreover, it should be borne in mind that, for all of the embodiments described up to now, when a vehicle on which the pad according to the invention is mounted is moving backwards, the references considered up to now are reversed. However, the principle of operation of the pad, and consequently the advantages resulting therefrom, remain the same.

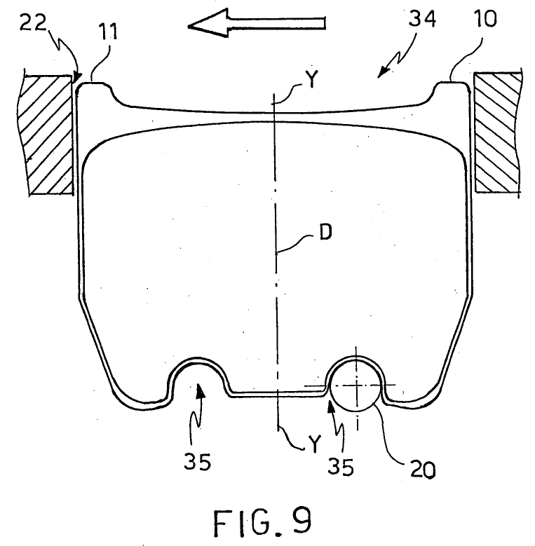

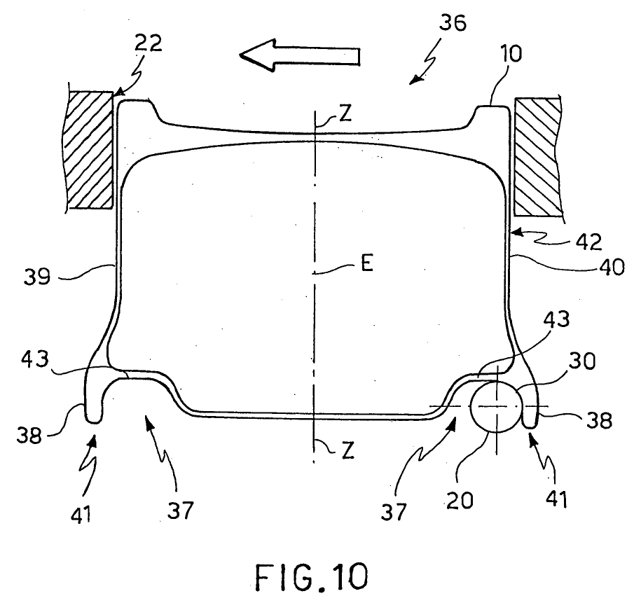

FIG. 9 shows a third variant of the invention in which the shape of the pad 34 is generally identical to the pads described above and the common parts therefore have the same reference numerals.

In particular, the pad 34 has two seats 35 which are just the same as the seat 12 described with reference, for example, to FIG. 1, and are positioned reflectively symmetrically with respect to the axis Y-Y extending through the centre of gravity D of the pad.

Moreover, in this embodiment also, the pad 34 can equally well be mounted on either of the two sides of a brake disc so that the seat 35 which is to the rear of the centre of gravity D can always house the support pin 20, without the need to provide reflectively symmetrical pads.

As described with reference to the previous embodiment, in this case also, the point of abutment between the pin 20 and the seat 35 is advantageously moved further towards the rear relative to the centre of gravity D of the pad 34.

FIG. 10 shows a fourth variant of the invention in which the pad 36 has a shape generally similar to the shape of the previous pads.

In contrast, this pad 36 has two seats 37 formed at the level of its opposite lower corners 41.

In particular, the seats 37 are defined by two arms 38 which extend downwards from the front and rear shorter sides 39 and 40 of the plate of the pad 36, as extensions thereof. The arms 38 are connected to the plate 42 of the pad 36 by means of respective elongate portions 43.

The main advantage afforded by this variant is that the point of abutment 30 between the support pin 20 and the seat 37 is moved as far as possible towards the rear relative to the centre of gravity of the pad.

In other words, the abutment point 30 has been brought to the vicinity of the lower rear corner of the pad 36. This achieves the maximum reduction in the so-called undesired “sticking” or “stick-slip” effect.

In addition, as for the embodiments described above, it should be noted that the abutment between the seat 37 and the pin 20 takes place not only to the rear of the centre of gravity E of the pad 36, but also at the rear of the support pin 20. In other words, the periphery of the pad 36 extends around the support pin 20, that is, precisely the opposite of what occurs in the pad described in the above-mentioned German patent DE 44 16 815.

In this case also, as for all of the previous embodiments, the pad 36 just described bears on a single pin.

As explained above, the pad 36 can equally well be mounted on either side of the brake disc so as to house the support pin 20 solely to the rear of the centre of gravity E of the pad.

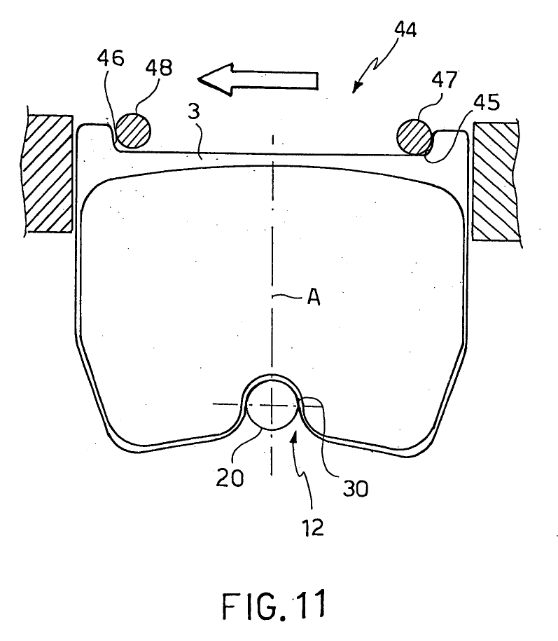

FIG. 11 shows a fifth variant of the invention in which, as before, the parts in common with the other embodiments are indicated by the same reference numerals.

The pad 44 has a shape substantially identical to that of the pad 1 described above and also has a similar seat 12 for receiving a corresponding support pin 20.

Moreover, a rear seat 45 and a front seat 46 are formed at the two corresponding ends of the longer side 4 of the plate 3.

The rear and front seats 45 and 46 are similar to the seats 37 described in FIG. 10 and are such as each to receive a corresponding rear or front reaction pin 47 or 48.

As shown in FIG. 6, during a braking operation, in addition to the discharge of some of the frictional force from the pad 44 to the pin 20 at the level of the abutment point 30, the remaining frictional force is thus discharged at the level of the abutment point between the rear seat 45 and the rear reaction pin 47.

It is clear from the foregoing description that the abutment surface 22 of the bridge 15 described above will no longer constitute a reaction point which opposes the frictional force, that is, a reaction point positioned towards the disc exit relative to the centre of gravity A of the pad 44. On the contrary, a reaction point is created which is positioned towards the disc entry relative to the centre of gravity A of the pad 44.

It should be borne in mind that, if the frictional force were directed in the opposite direction, the situation would be reflectively reversed so that the rear reaction pin 47 would come into play in the manner just explained.

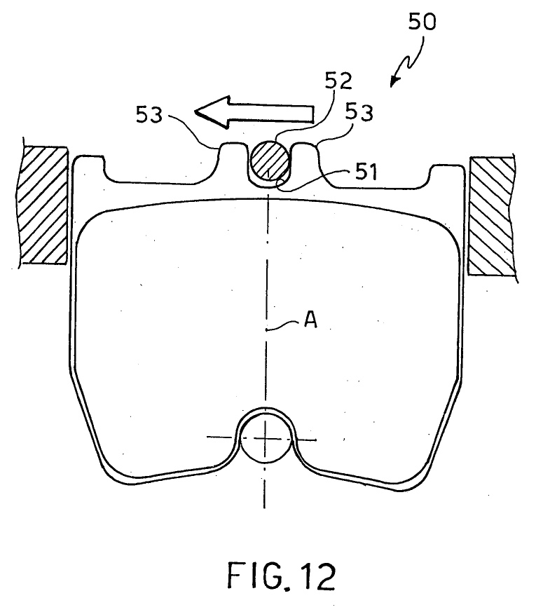

FIG. 12 shows a sixth variant of the invention in which the parts in common with the embodiments preceding FIG. 12 are indicated by the same reference numerals.

In comparison with the embodiment of FIG. 11, the embodiment of FIG. 12 has a single further seat 51 defined by two protuberances 53 which extend from the upper longer side 4, substantially in the vicinity of its centre, the further seat being engaged by a single reaction pin 52.

In comparison with the embodiment of FIG. 11, in this last embodiment, the number of reaction pins positioned on the upper longer side of the pad is advantageously reduced to one.

According to the foregoing description, by virtue of the provision of a seat positioned in a pad in a manner such as to be arranged astride and housing a support pin as shown in FIGS. 8 to 10, the action and reaction forces which come into play during a braking operation can be considered to be directed in a manner such as to bring about a kind of “stretching” of the pad.

As a result, should the pad tend to be inclined to the surface of the brake disc, the “stretching” effect would tend to return it to a position parallel to the brake disc and hence to a position of equilibrium in which the above-mentioned vibrations do not occur.

In contrast, according to the prior art discussed in the introductory portion of the present description, the action and reaction forces during a braking operation are directed in a manner such as to bring about a kind of “compression” of the pad.

Should the pad tend to be inclined to the surface of the brake disc, the “compression” effect would consequently tend to increase this inclination and hence to favour the occurrence of vibrations.

In addition, it has surprisingly been observed that the above-mentioned “stretching” effect is increased by the provision of a further point of reaction to the frictional force, positioned at the top of the pad and moved towards the disc entry relative to the centre of gravity of the pad, as shown in FIGS. 11 and 12.

Many variations and modifications may be applied to the pad of the present invention.

For example, the caliper body 14 may be formed by joining together two separate half-bodies, assembled by conventional fixing means such as screws or bolts.

The seats 32, 35 and 37 for a pin which are described with reference to FIGS. 8 to 12, respectively, may be square as described with reference to the seat 27 of FIG. 7.

As will be appreciated from the foregoing description, the pad for calipers according to the invention overcomes the disadvantages of the pads of the prior art.

Naturally, in order to satisfy contingent and specific requirements, a person skilled in the art may apply to the above-described pad for disc-brake calipers many modifications and variations all of which, however, are included within the scope of the invention as defined by the appended claims.

What is claimed is:

1. A pad for disc-brake calipers, comprising a plate for supporting a friction lining and having at least one seat which can engage a corresponding support pin suitable for supporting the pad in a caliper body, the support pin establishing a reaction to the frictional force exerted by a brake disc against the friction lining during a braking operation, in which the at least one seat is formed at the bottom in a manner such that the pad is supported astride the support pin and that the point of abutment of the support pin in the seat is disposed to the rear of the centre of gravity of the pad.

2. A pad according to claim 1 in which the seat has a semicircular profile in order to be positioned astride the support pin substantially precisely.

3. A pad according to claim 2 in which the point of abutment of the support pin in the seat is disposed in the quarter circle which is to the rear of the centre of gravity of the pad.

4. A pad according to claim 1 in which the seat has a substantially square profile defined by two opposed surfaces and a base.

5. A pad according to claim 4 in which the point of abutment between the support pin and the seat is represented by the point of contact between the support pin and the surface situated to the rear of the centre of gravity of the pad.

6. A pad according to claim 1 in which the seat has a substantially rectangular profile so as to receive the support pin to the rear of the centre of gravity of the pad.

7. A pad according to claim 1, comprising two seats which are arranged symmetrically with respect to the axis of the pad, and of which solely the seat which is disposed to the rear of the centre of gravity of the pad houses the support pin.

8. A pad according to claim 7 in which the seats are positioned at the opposed lower corners of the pad.

9. A pad according to claim 7 in which the seats are defined at the lower corners of the pad by two arms which are connected to a body of the pad by means of respective elongate portions.

10. A pad according to claim 1, comprising stop means which cooperate with corresponding opposed stop means provided on a caliper body in order to restrain the pad from moving in the direction of the rotation of a brake disc during a braking operation.

11. A pad according to claim 10 in which the stop means comprise projections which extend at the top of the pad.

12. A pad according to claim 1, comprising at least one further seat positioned at the top of the pad and suitable for housing a reaction pin so as to form a point of abutment between the further seat and the reaction pin which is offset towards the disc entry relative to the centre of gravity of the pad.

13. A pad according to claim 12 in which the at least one further seat is defined by two protuberances.

14. A pad according to claim 12, comprising a front seat for housing a front reaction pin and a rear seat for housing a rear reaction pin.

15. A caliper body comprising opposed stop means suitable for cooperating with the stop means of the pad comprising stop means which cooperate with corresponding opposed stop means provided on a caliper body in order to restrain the pad from moving in the direction of the rotation of a brake disc during a braking operation.

16. A caliper body comprising opposed stop means suitable for cooperating with the stop means of the pad comprising stop means which cooperate with corresponding opposed stop means provided on a caliper body in order to restrain the pad from moving in the direction of the rotation of a brake disc during a braking operation, wherein the stop means comprise projections which extend at the top of the pad.

17. A disc-brake caliper comprising a pad comprising a plate for supporting a friction lining and having at least one seat which can engage a corresponding support pin suitable for supporting the pad in a caliper body, the support pin establishing a reaction to the frictional force exerted by a brake disc against the friction lining during a braking operation, in which the at least one seat is formed at the bottom in a manner such that the pad is supported astride the support pin and that the point of abutment of the support pin in the seat is disposed to the rear of the centre of gravity of the pad.
